(19) United States
(12) Patent Application Publication
(10) Pub. No.: US 2013/0069359 A1
(43) Pub. Date: Mar. 21, 2013

(54) Wrap-Back Product Label

(71) Applicant: John Paul Sawinski, Flower Mound, TX (US)

(72) Inventor: John Paul Sawinski, Flower Mound, TX (US)

(21) Appl. No.: 13/238,208

(22) Filed: Sep. 21, 2011

(51) Int. Cl. B42D 15/00

(52) U.S. Cl. 283/81

(57) ABSTRACT

A wrap-back label with an overlapping hinged flap, which encircles the circumference of a container. The hinged flap covers approximately 180 degrees of circumference, is retained by adhesives or other means, has two different surfaces, and may be wrapped by the end user around the container in either the clockwise or counter-clockwise direction in order to reveal or obscure, in conjunction with the label substrate, two unique surfaces.

### CROSS REFERENCE TO RELATED APPLICATIONS

Not Applicable

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

It is often desirable that product labeling and appearance be different during manufacturing, shipment and sales than when the product is in use. Prior to use, products are subject to regulatory requirements and labels must list ingredients, safety information, instructions for use, disclaimers, company information, etc. However, once the product is purchased for use, and the user has made use of such information, the user may desire to alter the appearance or exterior function of the product. Such changes in appearance are usually for cosmetic reasons: a cover placed over a box of facial tissues in a bathroom is one example. In another case, serving-sized, disposable salt dispensers are often bulk-packaged with regulatory labeling on the outer packaging. Once the outer packing is removed, the individual salt dispensers have labeling that is more cosmetically pleasing and appropriate for table use. As a further example, in the case of canned goods, outer covers are often slipped over beverages by drinkers to promote their school or a favorite team, or to keep the contents cold.

Desirable changes in a container label may extend beyond cosmetic reasons; Different information may be useful after purchase, such as expanded directions for use, different languages, promotions, contests, alternative graphics, a write-on area, etc. Additionally, a desired change in exterior labeling may be functional, such as a non-slip grip, fluorescent colors, glow-in-the-dark material, insulating foam, thermally conductive material, reflective surfaces, flexible solar panels, etc.

The art most closely related to this invention is that of pharmaceutical products and pesticides, with segmented, secondary, accordion-folded labels, or a small booklet with expanded instructions printed on the inside, which is then affixed to the primary label. After purchase, the secondary label may be pulled loose and read.

### BRIEF SUMMARY OF THE INVENTION

The objective of this invention is to solve problems inherent in secondary labeling systems in such a way that a single label may, by virtue of its design, contain two completely different surfaces which may be obscured or exposed at will.

This invention solves the problem by incorporating, in one label, a portion of the label, printed on both sides, that is folded back upon itself and loosely adhered, covering 180 degrees of container circumference, so that it can be wound in either direction, and reattached, to expose two different label surfaces.

### BRIEF DESCRIPTION OF THE SEVERAL VIEWS OF THE DRAWING

FIG. 1: A typical product label, printed with an adhesive strip, and content indicated as surfaces ‘A’ and ‘B’, shown flat, prior to folding and application to a product.

FIG. 2: The label in the process of being folded so that approximately 1/3 of its length is folded back upon itself and attached to the adhesive strip, exposing the other half of the printed surface indicated as ‘A’.

FIG. 3: The folded label, flat, showing only the surface indicated as ‘A’, prior to being applied to a product.

FIG. 4: The label shown as it may be wrapped around a cylindrical product.

FIG. 5: The detachable portion of the label shown in the process of having been detached and being wound 180 degrees in the opposite direction.

FIG. 6: The detachable portion of the label shown as being fully wound in the opposite direction so that only the printed surface indicated as ‘B’ is visible.

### DETAILED DESCRIPTION OF THE INVENTION AND PREFERRED EMBODIMENT

The invention consists of a wrap-around label which covers approximately 1½ times the circumference of a container, printed fully on one side, and partially on the other, with the portion of the label printed on both sides folded back to form a flap which covers approximately 180 degrees of circumference, which is then loosely adhered to the label substrate by an adhesive strip or other means. Upon releasing the folded back portion and winding it around the container in the opposite direction, a completely new surface may be exposed, and the original surface obscured.

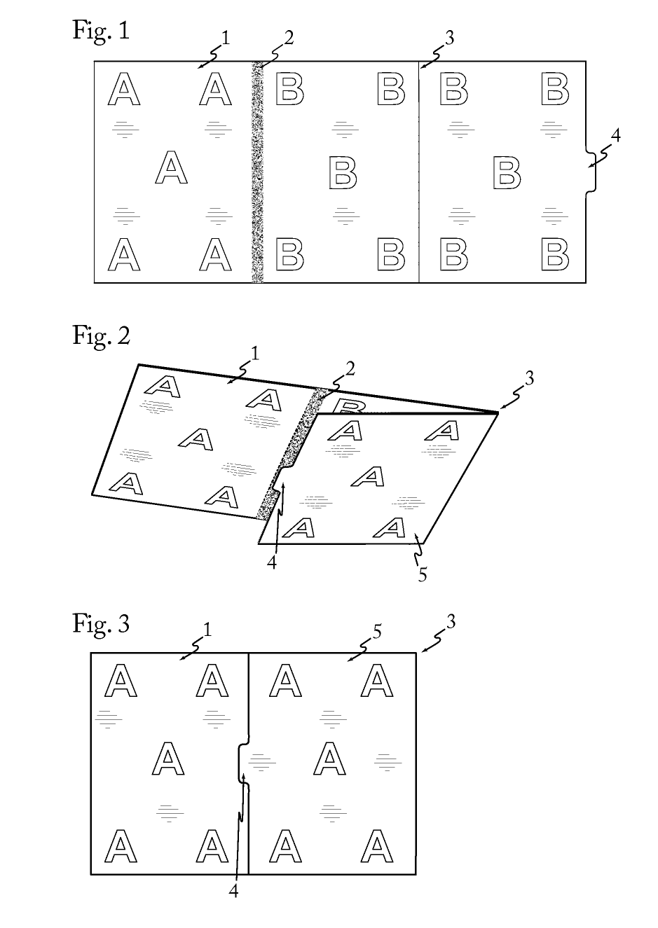

As shown in FIG. 1, a label substrate (1), composed of paper, plastic, deformable stretch fabric, metallic materials, or any other material, or combination of materials suitable for a label substrate, is divided approximately into thirds and printed on the front surface as shown, so that approximately half of the printed content shown as ‘A’ occupies one area, referred to as the ‘A’ surface, and all of the printed content shown as ‘B’, referred to as the ‘B’ surface, occupies the remainder. The thickness of the label substrate and the number of layers, and the composition of such layers, may be of any combination necessary to facilitate the various features of the invention as further described.

A low-strength adhesive strip (2) is applied between the ‘A’ and ‘B’ areas. Such an adhesive strip may be comprised of Krylon Easy-Tack Repositionable Adhesive or Scotch-Weld Spray 75 Repositionable Adhesive, or any such adhesive which adheres to the label substrate while permitting the flap to be released and reattached at will. The method of applying the adhesive may be by roller, spray, printing, transfer, film adhesive, or any method or material familiar to those skilled in the art.

The position of a fold line (3) is established so that when the label is folded, a flap is formed and the edge of the flap adheres to adhesive strip (2) with tab (4) protruding beyond the adhesive strip (2) so it does not adhere to the label substrate. Tab (4) provides a convenient feature for users to grip the label in order to detach it from the adhesive when desired. Tab (4) may be of any shape or size, or positioned anywhere relative to the flap, or made of any material to facilitate this function and to provide an appropriate appearance.

As shown in FIG. 2, when the label (1) is folded along fold line (3), a flap is formed and the other half of the ‘A’ surface, on the reverse side (5) of the label substrate, is exposed. When the fold is fully closed, the edge of the label flap then adheres to the label substrate on adhesive strip (2) so that tab (4) protrudes beyond adhesive strip (2), thus providing a convenient feature to grip the edge of the flap.

As shown in FIG. 3, the folded label (1), fully folded along fold line (3), now fully exposes reverse side (5) revealing fully the ‘A’ surface, while fully obscuring the ‘B’ surface, which is now inside the folded area.

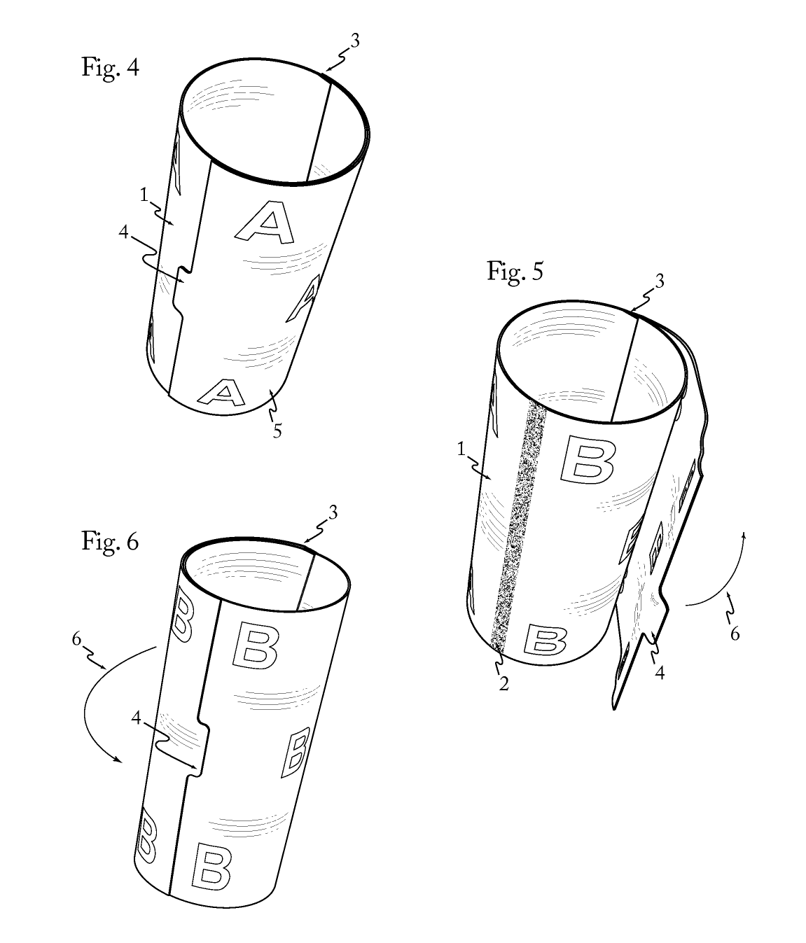

As shown in FIG. 4, the folded label (1) is shown wrapped in a cylindrical shape as it would be around a can, bottle, or other round container, so that the ‘A’ surface, including that visible on the reverse side (5), encircles the outside of the cylindrical shape, with tab (4) exposed and in a position to be gripped. The method of attaching the label to a container may be by any permanent, or semi-permanent means, including by spray adhesive such as Scotch type 90 adhesive, hot-melt adhesive, rolled glue, transfer adhesive, adhesive film, or by any means or method currently practiced by those skilled in the art of attaching labels to containers. In some cases it may be desirable that the label not be attached to the container, only wrapped around the circumference and glued to itself.

To facilitate this invention, the sole requirement of the label attachment method is that both edges of the label be affixed close to each other in order to fully encircle the container, and that an area of the unprinted side of the label adjacent to fold (3) be affixed to the container, or to the label itself, sufficiently well so that fold (3) acts as an anchored hinge for the folded flap.

FIG. 4 additionally indicates the label glued to itself at fold (3) by virtue of an overlap in the cylindrical wrap. Additionally, the label need not necessarily overlap itself, and may be glued to the container at both edges of the label so that the label edges form a butt joint. Additionally, the shape of the container need not be cylindrical, and may be oval, square, rectangular, or any shape around which a label may be wrapped. Where it may be desirable to use this invention in regards to irregular shapes, or containers shaped without parallel edges, the label substrate may be made of a deformable material such as rubber, stretch fabric, plastic, woven metal, or any material, or combination of materials, suitable for the purpose of making a flexible label that conforms to the shape of a container.

FIG. 5 shows the function of the wrap-back feature of the folded label (1), where force on tab (4) has released the folded flap from adhesive strip (2) and the flap is being unfolded along fold line (3) in direction (6), to eventually wrap approximately 180 degrees in the opposite direction, to be reattached to adhesive strip (2) from the opposite direction.

FIG. 6 shows the completion of the wrap-back process of FIG. 5 along fold line (3) in direction (6) so that the edge of the folded flap now adheres to the adhesive strip on the opposite side, in the opposite direction, and tab (4) protrudes beyond the edge of the adhesive, also in the opposite direction. At the completion of the wrap-back process, surface ‘B’ is now fully exposed and surface ‘A’ is now fully obscured.

Should it be desirable that the folded flap be restored to its original position, tab (4) may again be grasped, the edge of the folded flap released from the adhesive, and the folded flap may be rewound in the original direction, at which time the folded flap may be pressed down on the adhesive strip to complete the process of restoring the flap to its original position.

### Variations of the Preferred Embodiment

The overall size of the label substrate and position of the fold line is generally determined by the circumference of the container around which the label is to be wrapped, so that the folded flap wraps slightly more than 180 degrees around the circumference, enough so that the folded flap overlaps the adhesive strip in both directions. However, in some cases, it may be desirable to have the folded flap cover a greater or lesser circumference of the container. In such cases, affixing the folded flap in a particular position may be facilitated by an additional adhesive strip added to the label substrate, or to one, or to both sides of the edge of the folded flap adjacent to the tab. In any case, an adhesive pattern of any size or shape may be added to the label substrate in any position, or to the flap, in order to facilitate adhesion of any size folded flap when wrapped in either direction.

It may also be desirable to control the adhesion properties of the adhesive strip so that when the folded flap is released and wrapped in the opposite direction, the adhesive bond in that position is lesser, stronger, or more permanent than when wrapped in the original direction. In such cases, the area of the folded flap which contacts the adhesive strip may be laminated with, or treated with, a material such as acrylic plastic, paint, Teflon tape, chemical reactants, adhesive or adhesive components, or any permanent or removable material which facilitates easier release from the adhesive strip, or greater adhesion, as desired. Such treatment or treatments may be applied to either or to both sides of the folded flap in order to enhance adhesion characteristics in either wrapped position.

A similar treatment or treatments may also be applied to strengthen the label material or the folded flap in cases where the adhesion strength of the adhesive strip is so strong that tearing of the label, folded flap, or tab might occur.

In cases where it is desirable to form adhesive strips on the label substrate or on the folded flap, which may be exposed in some positions, such adhesive strips may be covered prior to use by removable strips of a easy-release film such as that used for Band-Aid bandages or adhesive labels.

A variation of this invention is facilitated when permanent adhesive, such as Scotch Type 90 spray adhesive, is applied to either the label substrate, or to the edge of the flap, which is then protected by an easy-release film as noted previously until ready for use. In such cases, the flap may adhere to the label substrate minimally, or not at all, until the quick release film is removed and the adhesive strip thus activated or exposed. Additionally, in this case, prior to use the flap may be retained by a piece of low adhesive strength tape, a tear-off paper band around the circumference of the container, shrink-wrap plastic, a rubber band, or any other kind of temporary fastening method to retain the flap which is known to those skilled in the art. When the temporary fastening material is removed, the folded flap would thus no longer be restrained, the adhesive strip may then be exposed or activated by removing the protective film, the flap wound in the desired direction, pressed down on the exposed or activated adhesive, and the resulting bond made permanent.

Similarly, the adhesive material in the adhesive strip need not be homogenous along its length or width; By applying different adhesive materials in different places, those materials may contact areas of the folded flap which are similarly treated to facilitate greater or lesser adhesive force as previously described.

Additionally, an adhesive strip may be applied to the ‘A’ surface of the folded flap rather than to the label substrate. In such cases, the temporary fastening material, which retains the folded flap prior to being wrapped to expose the ‘B’ surface, may be formed as one continuous piece comprised of temporary fastening material to hold the folded flap in position and a quick release film which protects the adhesive strip. Prior to use, where the ‘A’ surface is exposed and the ‘B’ surface obscured, the temporary fastening material/quick release film would thus hold the folded flap in position while also covering the adhesive strip which would otherwise be exposed. When it is desired to wrap the folded flap so that the ‘B’ surface is exposed, the temporary fastening material/quick release film is removed as one piece, the folded flap released, wrapped in the reverse direction, and the exposed adhesive strip on the ‘A’ surface pressed against the label substrate to complete the bond.

Another variation of this invention may be used when it is not desirable to use adhesives. In such cases, other means may be used to retain the flap, such as magnetic strips, Velcro hook and loop strips, a slot cut in the label substrate to accommodate the tab, or any other method commonly used to affix materials that is suitable for the purpose of this invention.

A variation of this invention may be used to control the thermal properties of a container. For example, in the folded state where surface ‘A’ is exposed, a thermally conductive material such as a metallic foil may be incorporated into the label substrate and exposed on half the circumference, thus permitting the contents of the container to be more rapidly heated or cooled. Additionally, in the wrapped state that causes the ‘B’ surface to be exposed, an insulating material such as closed cell Neoprene rubber, hollow fiber cloth, Styrofoam plastic, or any layered or non-layered insulating material may be incorporated into the ‘B’ surface and thus fully encircle the container, enabling the liquid to remain hot or cold longer. As a useful novelty, a pattern of temperature-sensitive liquid crystal material, such as that used for stick-on thermometers, may be included on either the ‘A’ or ‘B’ surface in order to indicate the temperature of the contents.

An additional variation of this invention may be used to disperse chemicals such as scented material, insect repellent or attractant, or any material which might be desirable to disperse through evaporation or contact. In this variation, surface ‘B’ contains the material to be dispersed, which is exposed when the folded flap is wound in the reverse direction. The label substrate and the material or materials used to contain the dispersant would be constructed suitable to its function, and so that the dispersant will not disperse when the folded flap is wound so that the ‘B’ surface is obscured. Materials suitable for the ‘B’ surface in this case may be absorbent paper, cellulose sponge, open-celled plastics, gelatin film, or any flexible material suitable for the purpose of retaining and releasing chemicals. Should it be necessary to thoroughly seal the dispersant prior to use, the edges of the folded flap may be further sealed with removable tape, Mylar film, heat shrink plastic, wax, or any removable material which prevents the dispersant from dispersing prior to use. Additionally, to seal the contents of a dispersant, the edges of the ‘B’ surface, or the entire ‘B’ surface, may be laminated with a thin plastic film with the perimeter of that film, or a portion of its perimeter, formed into a reusable seal such as that used for Ziploc plastic bags or re-sealable bags of frozen vegetables, thus forming a sealed pouch prior to engaging the wrap-back function of the folded flap. Such a reusable seal may also be used to retain the folded flap in lieu of adhesives or other fastening devices.

In conjunction with the above variation, a chemical reactant or reactants may be sealed into the ‘B’ surface, which may be activated as desired by the user to heat the liquid in the container. When the seal on the folded flap is broken, and the folded flap positioned so that the ‘B’ surface is exposed, the chemical reactants are activated, either by exposure to air or by other means, and thus generate heat, which is then thermally conducted through the label substrate into the container. Such a feature would be similar to that of single-use hand warmers which begin an exothermic chemical reaction when a sealed pouch is opened. A layer of insulation may be added to the ‘B’ surface to prevent burns or discomfort to the user. Such insulation would be porous to air, or otherwise designed to facilitate the chemical reaction while providing insulating properties.

Another variation of this invention may be used when it is desirable that the material used for the folded flap be different from that of the label substrate, or in order to facilitate container manufacturing and labeling processes: For example, where labels may be provided on a continuous roll prior to application to the container it may not be practical to manufacture the folded flap from one continuous label substrate. In such cases, the label and the folded flap may consist of two separate pieces, supplied separately, flat and individually, or on continuous rolls which are designed to be cut during application to the container. In such cases, the folded flap would consist of a separate piece of material that is permanently glued to the label or container in the area of the fold line, before or after the rest of the label has been applied to the container. The folded flap would be attached in such a manner that the invention would be function as previously described. The size and shape of the attachment area, its location, and the nature of the adhesive used to attach the folded flap may be of any type necessary to facilitate the invention, and will be apparent to those skilled in the art. Additionally, whether or not the folded flap is applied with the fold already made, or not, may depend on the material, cosmetic appearance or other functional considerations, and is at the discretion of the manufacturer.

Any feature or variation of this invention may be combined with any other in order to facilitate a greater number of inventions.

1) A wrap-back label which covers the circumference of a container, with a repositionable flap which covers a portion of the circumference so that it may be wound in either the clockwise or counter-clockwise direction in order to hide or obscure two different surfaces.

2) The use of adhesives or other attachment methods on a wrap-back label to retain a repositionable flap relative to a label substrate so that it may be wrapped in either direction around a container and released from a position, or affixed in a position.

3) The application of various materials and sealing methods to the surfaces of a wrap-back label, so that different printed content, cosmetic effects or functional properties may be visible, obscured, enabled or disabled when a repositionable flap is wrapped partially around the circumference of a container in either the clockwise or counter-clockwise direction.

4) A wrap-back label that provides a substrate to affix subsequent materials such as, but not limited to, inks, dyes, fragrances, insulating or thermally-conductive layers, non-slip grip layers, temperature indicating materials, chemical reactants and photographic images.
